(19) United States
(12) Patent Application Publication
(10) Pub. No.: US 2017/0034886 A1
(43) Pub. Date: Feb. 2, 2017

(54) INTEGRATED DEVICE FOR ADJUSTING DIMMING OF LEDS, AND CONTROL METHOD

(71) Applicant: STMicroelectronics S.r.l., Agrate Brianza (IT)

(72) Inventors: Edmondo Gangi, S. Agata Li Battiati (CT) (IT); Salvatore Rosario Musumeci, Fiumefreddo Di Sic (IT); Fabio Occhipinti, Catania (IT)

(73) Assignee: STMicroelectronics S.r.l., Agrate Brianza (IT)

(21) Appl. No.: 15/138,281

(22) Filed: Apr. 26, 2016

(30) Foreign Application Priority Data
Jul. 27, 2015 (IT) 102015000038443

(51) Int. Cl. H05B 33/08

(52) U.S. Cl. CPC H05B 33/0845; H05B 33/0815

(57) ABSTRACT

An integrated device for adjusting dimming of LEDs includes a law memory storing a switching control law for LEDs. A modulated-clock generator coupled to an output of the law memory generates a modulated-clock signal having a parameter that varies according to the stored switching control law. A count stage coupled to an output of the modulated-clock generator generates a variable-frequency count signal. A comparator has an input coupled to an output of the count stage and compares the count signal with a setting value to generate a control signal for a LED channel that switches when the count signal reaches the setting value.

### PRIORITY CLAIM

This application claims priority from Italian Application for Patent No. 102015000038443 filed Jul. 27, 2015, the disclosure of which is incorporated by reference.

### TECHNICAL FIELD

The present invention relates to an integrated device for adjusting dimming of LEDs and to the control method.

### BACKGROUND

As is known, the use of LEDs in lighting apparatuses is increasing, at the expense of traditional lighting techniques based upon incandescent, fluorescent, or halogen lamps, by virtue of the possibility of availing arrays of diodes arranged side-by-side and able to supply a high brightness at a high efficiency. LED lighting apparatuses thus have increasingly wider application both in the automotive field, for position lamps and headlights, and in civil engineering, for outdoor and indoor lighting lamps.

Control of brightness of LED arrays is not, however, simple. In fact, the human eye has a response of a logarithmic type to the variation rate of the light. Consequently, to obtain a variation of brightness perceived as linear by the human eye, the LEDs are driven with a signal that follows an exponential law.

Currently, control of brightness is obtained by pulse-width modulation (PWM). Consequently, to obtain a brightness variation that is perceived by the human eye as constant in time, the diodes or arrays of diodes are driven with control pulses having an exponentially increasing duration.

In practice, to this end, current adjustment devices comprise a stage that stores the exponential conversion law and outputs each instant the duration value (or duty cycle) of the control signal.

With the same technique, in order to enable different adjustment profiles that provide non-linear effects of blinking, sleeping, or dimming, the control laws are stored in the adjustment device.

The general diagram of a dimmer that uses the technique described above is shown, for example, in FIG. 1.

The dimmer of FIG. 1, designated as a whole by 10, comprises a control unit 13, here represented schematically by a finite-state machine FSM; a memory stage 14, here represented schematically as a register, controlled by the control unit 13 and storing the configuration parameters; a dimming block 15, controlled by the control unit 13 and receiving the configuration parameters from the memory stage 14; and a clock 16, generating clock pulses CLK supplied to the control unit 13 and to the dimming block 15 for timing the dimmer 10.

The dimming block 15 stores the desired conversion law and outputs a control signal Ton, of a digital type, supplied to a driving circuit 18, in turn driving a diode or an array of diodes 19.

FIG. 2 shows a known embodiment of the dimming block 15 for simultaneously controlling a plurality of LEDs or strings of LEDs, also referred to as channels C1, C2, . . . Cn, which receive respective control signals Ton.1, Ton.2, . . . Ton.n from respective outputs of the dimming block 15.

The dimming block 15 comprises a conversion element 20, implemented as a look-up table, a counter 21, and a plurality of comparators 23.1, 23.2, . . . 23.n, one for each channel C1-Cn.

In detail, the conversion unit 20 is coupled to the memory stage 14, here implemented as block of channel registers 14, one for each channel C1-Cn, designated also as 14.1, 14.2, . . . 14.n. In particular, the conversion unit 20 has a plurality of inputs, each connected to a respective channel register 14, 14.1, 14.2, . . . 14.n and has a plurality of outputs, each connected to a respective comparator 23.1, 23.2, . . . 23.n. The counter 21 receives the clock signal CLK and outputs a count signal supplied to the comparators 23.1, 23.2, . . . 23.n, the outputs whereof supply control signals Ton.1, Ton.2, . . . Ton.n.

In practice, at each cycle, on the basis also of the control signals from the control unit 13, the conversion unit 20 outputs a plurality of values of pulse duration, one for each channel C1, C2, Cn, supplied to the comparators 23.1, 23.2, . . . 23.n, together with the count signal. At the start of each cycle, each comparator 23.1, 23.2, . . . 23.n generates, on the respective output, a switching edge (for example, a rising edge) and then switches in an opposite way (for example, via a falling edge) as soon as the count value supplied by the counter 21 becomes equal to the value supplied by the conversion unit 20. Thus a pulse is generated, the duration whereof is determined by the conversion values stored in the memory locations of the look-up table 20, on the basis of the addresses specified by the channel registers 14.

In this way, even though all the channels use one and the same ON law (for example, an exponential law, perceived by the human eye as a linear law), the individual channels can independently and proportionally modulate the obtainable brightness.

If it is desired to implement more than one conversion law, for example for generating animations that require fast variations of brightness of the diodes or LED arrays according to preset patterns, it is possible to program the conversion unit 20 to store different conversion laws. In this case, the dimmer 10 may include a plurality of registers that encode in a binary way the conversion law to be used each time, as represented in FIG. 2 by a block of law-selection registers 25.

For example, the component PCA9622 produced by NXP Semiconductors, which uses a scheme similar to the one described above, enables driving of 16-bit LEDs for implementing a law of a linear type. If it is desired to implement more than one conversion law, the above component enables implementation of more complex laws, but this requires extra area for implementation of the desired functions.

With the dimmer 10 of FIGS. 1 and 2, setting of a number of laws entails a high complexity, which causes an extensive integration area and a high programming complexity when it is desired to add or modify the brightness-variation laws.

In fact, for a dimmer 10 having the following parameters:
f_{clk}and T_{clk} =frequency and the period, respectively, of the signal CLK of the clock 16;
Δ_{pwm}=minimum difference in duration |D.i(k)−D.i(j+1)|, measured as number of clock cycles, between two successive pulses of the control signals Ton.1, Ton.2, . . . Ton.n (see FIG. 3);
T_{pwm}=PWM adjustment period corresponding to a 100% Tₒₙ (see FIG. 3);
PWMᵣₑₛ=resolution in bits of the PWM adjustment (in practice, the greater this parameter, the smaller the unit brightness increase and thus the finer the brightness adjustment);
NL=number of adjustment laws that are to be implemented via the dimmer 10; and
k=non-proportional complexity factor correlated to the dimensions of the addressing part of the look-up table 20;

and naming:
CountS, the dimensions of the counter 21;
RS, the dimensions of the channel registers 14;
LUTS, the dimensions of the look-up table 20 measured in words*bits*k;
CompS, the dimensions of the comparators 23 (understood as combinational-logic complexity); and
LAWₛₑₗ, the number of bits necessary for addressing the various laws, the dimmer 10 has the following complexity:

$$CountS = [ {log}_{2} ( \frac{{T}_{pwm}}{{T}_{clk} \cdot {Δ}_{pwm}} ) ]$$

$$RS = n \cdot {PWM}_{res}$$

$${LAW}_{sel} = ⌈ {log}_{2} ( NL ) ⌉$$

$$LUTS = ( {2}^{{PWM}_{res}} ) \cdot ( CountS \cdot NL ) \cdot ( 1 + k \cdot n )$$

$$CompS = n \cdot CountS$$

which is more than proportional to the parameters to be modified.

Each variation of dimensions, of the conversion laws to be implemented, and/or of the channels thus entails a high increase of the complexity of the adjustment device of FIGS. 1 and 2.

In fact, the look-up table is currently implemented in a wired way via diffusions within a silicon substrate, and each modification requires a new design step, with modification of a large number of the diffusion masks (up to thirty) and execution of a complete qualification step, an operation that is costly and involves a non-negligible length of time.

In addition, with the described solution, the implementation of more than one law at a time would require a very extensive area in so far as it would involve multiple look-up tables as well as creation of a combinational logic for decoding the information from the tables.

There is a need in the art to provide a dimmer that overcomes the drawbacks of the prior art.

### SUMMARY

In an embodiment, an integrated device for adjusting dimming of LEDs and an adjustment method are provided.

In practice, the present dimmer replaces the operations of counting of clock pulses at a constant rate and of comparing the results of the count with various values stored for each channel for driving the LEDs or strings of LEDs with generation and counting of pulses of a non-constant clock, which is variable on the basis of the stored control law. In this way, the width of the driving pulses does not depend any longer upon counting a variable number of clock pulses at a fixed frequency, but depends upon counting the pulses of a non-constant clock, in particular having a variable frequency. The clock parameters, which vary according to the switching law be implemented, are stored in a non-volatile memory (ROM), which can be easily updated on the basis of the requests of the user.

It follows that the time processing is shared by all the LED channels. The use of a ROM moreover enables easy implementation of and switching between various laws, according to the dimensions of the chosen ROM. Moreover, adaptation of the design of the device to various driving laws can be obtained simply by modifying only a final mask in the manufacturing process.

In an embodiment, an integrated device for adjusting dimming of LEDs comprises: a law memory configured to store at least one switching control law for the LEDs; a modulated-clock generator coupled to an output of the law memory and configured to generate a modulated-clock signal having a parameter varying according to the stored switching control law; a counting circuit coupled to an output of the modulated-clock generator and configured to generate a variable-frequency count signal; and a comparator having an input coupled to an output of the counting circuit and configured to compare the count signal with a set value and to generate a control signal for an LED channel, said control signal switching when the count signal reaches the set value.

In an embodiment, a control method for adjusting dimming of LEDs, comprising the steps of: storing in a memory a switching control law for LEDs; generating a modulated-clock signal having a parameter that varies according to the stored switching control law; generating a counting signal of the modulated-clock signal; comparing the counting signal with a set value; and generating a switching control signal when the counting signal reaches the set value.

In an embodiment, an integrated device comprises: a modulated-clock generator configured to generate a modulated-clock signal having a frequency that varies according to a switching control law; a counting circuit configured to generate a variable-frequency count signal in response to the modulated-clock signal; a comparator having an input coupled to an output of the counting circuit and configured to compare the variable-frequency count signal with a set value and to generate a control signal that switches when the count signal reaches the set value; and a driver circuit operating in response to the control signal to drive a string of light emitting diodes (LEDs).

### BRIEF DESCRIPTION OF THE DRAWINGS

For a better understanding of the present invention preferred embodiments thereof are now described, purely by way of non-limiting example, with reference to the attached drawings, wherein:

FIG. 1 shows a general block diagram of a known dimmer;

FIG. 2 shows a more detailed block diagram of the dimmer of FIG. 1;

FIG. 3 shows the timing diagrams of some signals of the dimmer of FIG. 2;

FIG. 4 shows a block diagram of an embodiment of the present dimmer;

FIGS. 5A and 5B show the timing diagrams of some signals of the dimmer of FIG. 4; and

FIG. 6 shows a different embodiment of the present dimmer.

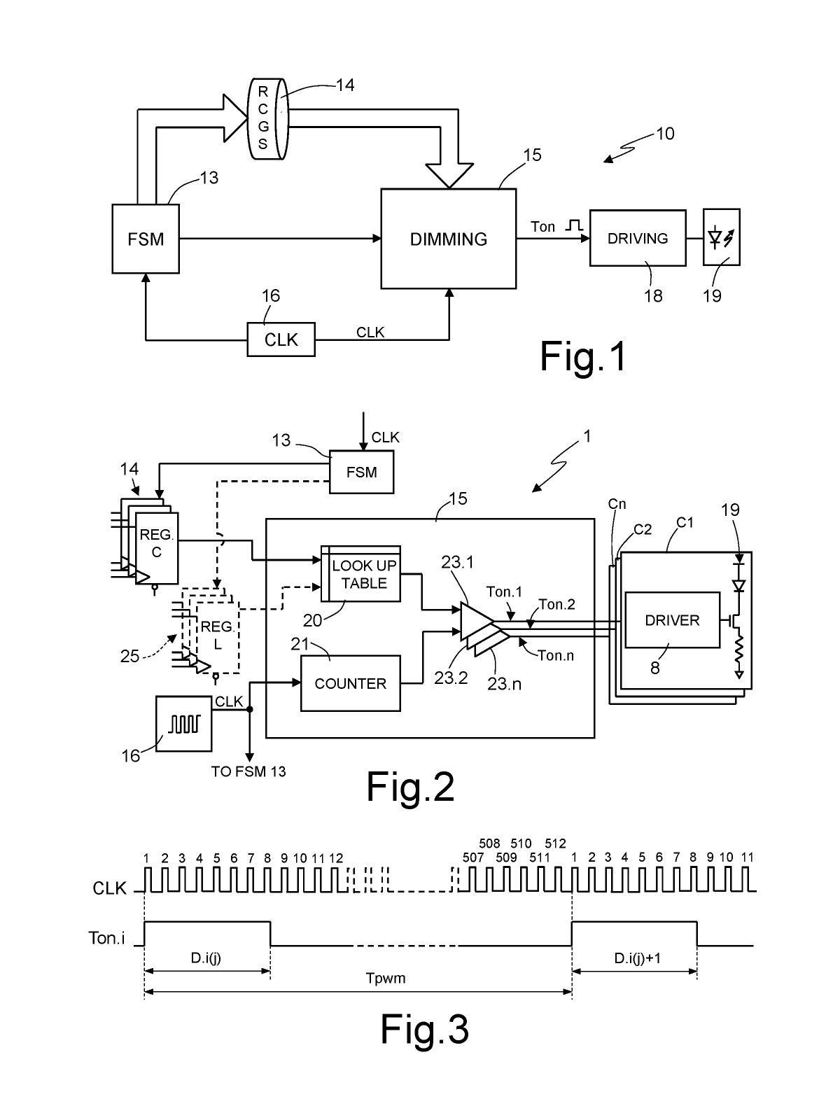

### DETAILED DESCRIPTION

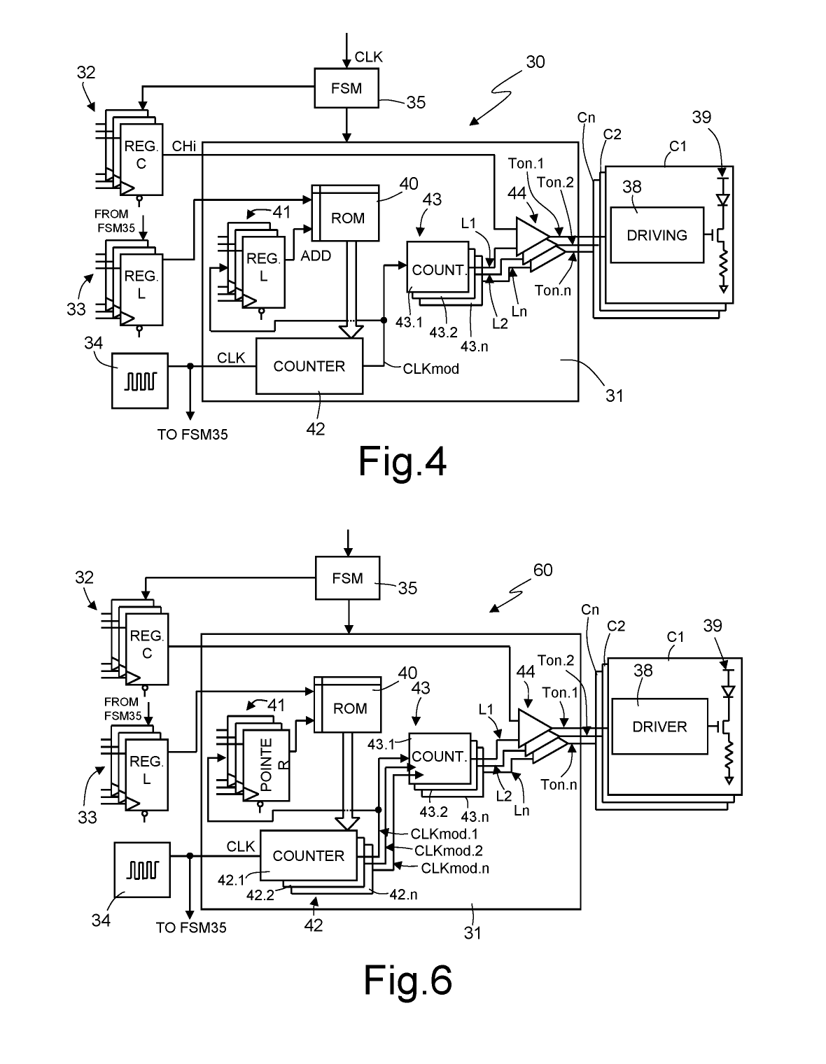

FIG. 4 shows the block diagram of a dimmer 30 designed to control a plurality of channels C1, C2, Cn, each formed by a driving circuit 38 and a respective LED or string of LEDs 39.

The dimmer 30 comprises a control unit 35; a dimming block 31; a block of channel registers 32; a block of law-selection registers 33; and a clock 34.

The control unit 35, also here a finite-state machine FSM, the block of law-selection registers 33, and the clock 34 are similar to the components 13, 25, and 16 of the dimmer 10 of FIG. 2 of the same name. Here, the channel registers 32 store the setting values for the respective channels so as to be able to independently and proportionally modulate the brightness obtainable on each channel. The control unit 35 has, amongst other things, the function of writing the setting values in the channel registers 32, as well as the law to be applied in the specific application, by setting he law-selection registers 33. Moreover, the control unit 35 receives the clock signal CLK generated by the clock 34.

The dimming block 31 comprises a memory 40, for example a ROM, which has inputs coupled to the block of law-selection registers 33 and to a pointer 41, and an output coupled to a first counter 42. The first counter 42 receives the clock signal CLK generated by the clock 34 and outputs a modulated-clock signal CLKmod which is supplied to a block of second counters 43. The block of second counters 43 comprises a plurality of second counters 43.1, 43.2, . . . 43.n, one for each channel C1, C2, . . . Cn, all whereof receive a same modulated-clock signal CLKmod. Moreover, the second counters 43.1, 43.2, . . . 43.n have a respective output connected to a respective first input of a block of comparators 44, one for each channel C1, C2, . . . Cn, which are also designated as comparators 44.1, 44.2, . . . 44.n. The output of each comparator 44.1, 44.2, . . . 44.n, which supplies a respective control signal Ton.1, Ton.2, . . . Ton.n, is coupled to a respective channel C1, C2, . . . Cn.

In detail, the memory 40, typically a ROM, stores the parameters used by the first counter 42 for generating the modulated-clock signal CLKmod for each brightness-variation law, selected on the basis of the information stored in the law-selection registers 33. Specifically, for each cycle of the control signals Ton.1, Ton.2, . . . Ton.n, and according to the stored law, as specified by the block of law-selection registers 33, the memory 40 supplies a sequence of values representing the number of pulses of the clock signal CLK at which the first counter 42 has to generate a pulse (pulse of the modulated-clock signal CLKmod), which represents the end-of-count or timeout signal for the first counter 42. In practice, the first counter 42 generates a pulse of the modulated-clock signal CLKmod after it has counted the number of clock pulses CLK specified each time by the memory 40.

Upon reception of each pulse of the modulated-clock signal CLKmod, the pointer 41 generates an addressing signal ADD, which is supplied to the memory 44. Upon reception of each pulse of the modulated-clock signal CLKmod, the pointer 41 increments the value of the addressing signal ADD, thus causing reading of the next position in the memory 40 and sending, to the first counter 42, a next duration value, thus determining progressive reading of the values stored in the memory 40. After reading the last value stored for the selected law, the pointers 41 are again initialized in an iterative way, so as to point to the start of the values sequence for the considered law, and a new driving cycle is thus activated.

The pulses of the modulated-clock signal CLKmod are counted by the second counters 43.1, 43.2, . . . 43.n, and the corresponding count signals L1, . . . Ln are supplied to the respective comparators 44.1, . . . 44.n. These compare the count signals L1, . . . Ln with the respective setting values supplied by the respective channel registers 32 and generate the control signals Ton.1, Ton.2, . . . Ton.n, which switch when the respective count signal L1, . . . Ln is equal to the setting value. For example, the control signals Ton.1, Ton.2, . . . Ton.n switch to high at the start of each period (when the count signals L1, . . . Ln go to zero) and switch to low when the respective count signal L1, . . . Ln reaches the respective setting value.

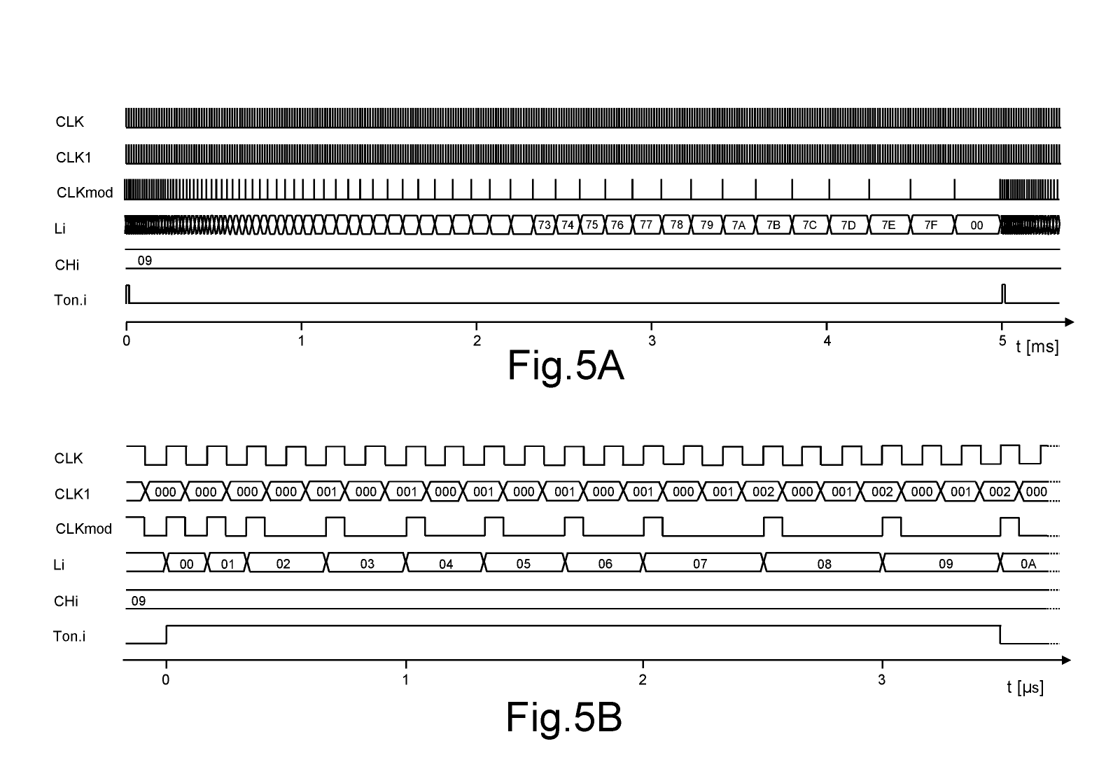

An example of variation of the signals of the dimmer 30 for controlling the channels C1-Cn with control signals Ton.1, Ton.2, Ton.n having a duration increasing according to an exponential law (which can be perceived by the human eye as linear variation of brightness) is shown in FIGS. 5A and 5B. These figures, in addition to the clock signal CLK, to the modified clock signal CLKmod, to the count signal Li referred to a generic channel Ci and to the corresponding control signal Ton.i, also show the internal count CLK1 of the first counter 42 (progressive up-count on three hexadecimal digits with setting value Chi, which is supplied to the i-th comparator 44.i, that constant and different for each channel, here equal to 0).

Here, the memory 40 supplies a sequence of increasing numbers of clock pulses (not shown). Consequently, as may be noted in the enlarged detail of FIG. 5B, the first counter 42 generates a series of pulses of the modulated-clock signal CLKmod, at a distance from one another that increases exponentially. In other words, the modulated-clock signal CLKmod has a period that is non-constant, and increases, and thus a frequency that is also non-constant, and decreases.

It follows that also the count signal Li generated by the second counter 43.i has an exponentially decreasing count frequency, thus determining control pulses Ton.i that are progressively longer.

Obviously, the sequences of modification of the duration of the ON pulses of the channels depends upon the law stored in the memory 40 and activated at that moment by the law-selection registers 33.

With the described dimmer 30, it is possible to easily implement numerous control laws, with reduced complexity and reduction in the adaptation operations of the device in order to adapt to new laws.

In fact, adopting the same terminology used above, and, namely:
NL is the number of adjustment laws to be implemented via the dimmer 30;
PWMᵣₑₛ is the resolution in bits of the PWM adjustment (in practice, the greater this parameter, the smaller the brightness increase step and thus the finer the dimming adjustment); and
Law_{scl} is the number of bits necessary for addressing the various laws, and moreover:
Δ_{pwm—step} is the difference of duration, as clock cycles CLK, between two ON pulses of the control signals Ton.1, Ton.2, Ton.n, which is stored as variation with respect to the preceding value in the memory 40;
C1_S are the dimensions of the first counter 42;
C2_S are the dimensions of the second counter 43;
ROM_S are the dimensions of the ROM 40, expressed as words*bits;
ROM_P are the dimensions of the pointer 41, in bits;
R_S are the dimensions of the channel registers 32, in bits; and
COMP_S are the dimensions of the comparators 44 (combinational logic), we obtain the following complexity:

C1₁₃ S=┌ log₂(Δ_{pwm}_{_}ₛₜₑₚ)┐

LAWₛₑₜ[FF]=┌ log₂(NL)┐

ROM_S=(2^{PWM}^{ᵣₑₛ})·C1_S

ROM_P=PWMᵣₑₛ+LAWₛₑᵢ

C2_S=n·PWMᵣₑₛ

R_S=n·PWMᵣₑₛ

COMP_S=n·PWMᵣₑₛ

For example, devices produced by the present applicant that implemented four different control laws for twelve channels C1-Cn used an integration area that was one third of the area necessary with the scheme of FIG. 2.

Moreover, by implementing the memory 40 as a ROM, the dimmer of FIG. 4 can be adapted to different control laws by simple modification of the data-storage mask. In fact, the implementation of the ROM in an integrated way in the dimmer 30 requires only the use of a purposely provided mask for etching a metallization level of the integrated device.

Thus, adaptation of the dimmer 30 for implementing various control laws does not require modification of diffusion masks in the silicon and thus not even performing the burdensome qualification step.

If it is desired to implement a dimmer where each channel C1-Cn can be controlled via a different control law, it is possible to use the scheme of FIG. 6.

In detail, the dimmer 50 of FIG. 6 comprises a plurality of first counters, designated by 42.1, 42.2, . . . 42.n, each whereof receives an own count value from the memory 40, on the basis of the respective law identified by the law-selection registers 33. The first counters 42.1, 42.2, . . . 42.n are moreover each coupled at output to a respective second counter 43.1, 43.2, 43.n.

In practice, in this case, the law-selection registers 33 can supply the memory 40 with the addresses corresponding to m laws (where 1≦m≦n). At each instant, on the basis of the location pointed by the pointer 41, the memory 40 supplies, on n outputs, n count values, and each first counter 42.1, 42.2, . . . 42.n generates a respective modulated-clock signal CLKmod.1, CLKmod.2, CLKmod.n, which can thus be generated at different times and give rise to pulses of different duration of the control signals Ton.1, Ton.2, Ton.n.

Finally, it is clear that modifications and variations may be made to the device and to the method described and illustrated herein, without thereby departing from the scope of the present invention, as defined in the attached claims. For example, by introducing simple delay elements between the first counter 42 and the second counters 43.1, 43.2, . . . 43.n (or, in the embodiment of FIG. 6, between the first counters 42.1, 42.2, . . . 42.n and the respective second counters 43.1, 43.2, . . . 43.n) or at output from the comparators 44, it is possible to use same control laws for at least some channels C1, C2, Cn, but delayed.

For example, the first counter could generate a signal, that, instead of having variable frequency, has a variable duration which is measured in some way by the second counter. In this case, the modulated-clock signal CLKmod could have an amplitude that is variable stepwise.

Moreover, the pointer could generate successive decreasing addresses, instead of increasing ones.

1. An integrated device for adjusting dimming of light emitting diodes (LEDs), comprising:
a law memory configured to store at least one switching control law for the LEDs;
a modulated-clock generator coupled to an output of the law memory and configured to generate a modulated-clock signal having a parameter varying according to the stored switching control law;
a counting circuit coupled to an output of the modulated-clock generator and configured to generate a variable-frequency count signal; and
a comparator having an input coupled to an output of the counting circuit and configured to compare the variable-frequency count signal with a set value and to generate a control signal for an LED channel, said control signal switching when the count signal reaches the set value.

2. The device according to claim 1, wherein the law memory is configured to store a sequence of modulation values.

3. The device according to claim 2, wherein the law memory is a ROM.

4. The device according to claim 1, wherein the modulated-clock signal has a variable frequency.

5. The device according to claim 2, wherein the modulated-clock generator is a first counter configured to:
receive the sequence of modulation values; and
for each modulation value, count clock pulses at constant frequency and generate a modulated-clock pulse when the number of clock pulses at constant frequency is equal to the modulation value.

6. The device according to claim 5, wherein the law memory comprises an addressing input, and further comprising an address pointer having an input coupled to the output of the modulated-clock generator and an output coupled to the addressing input of the law memory, the address pointer configured to generate an addressing signal that varies progressively upon reception of each pulse of the modulated-clock signal.

7. The device according to claim 1, further comprising a law-selection stage coupled to a law-addressing input of the law memory.

8. The device according to claim 1, further comprising a plurality of channel-control outputs, wherein the counting circuit comprises a plurality of second counters having respective inputs coupled to the output of the modulated-clock generator and respective outputs configured to generate respective count signals, and the comparator comprises a plurality of comparators each having a respective input coupled to an output of a respective second counter and a respective output coupled to a respective channel-control output and configured to compare the respective count signal with a respective set value and generating a respective switching control signal when the respective count signal reaches the respective set value.

9. The device according to claim 1, wherein the modulated-clock generator comprises a plurality of first counters configured to:
receive each a respective sequence of modulation values; and
for each respective modulation value, count clock pulses at constant frequency and generate a respective modulated-clock pulse when the number of clock pulses at constant frequency is equal to the respective modulation value.

10. A control method for adjusting dimming of LEDs, comprising the steps of:
storing in a memory a switching control law for LEDs;
generating a modulated-clock signal having a parameter that varies according to the stored switching control law;
generating a counting signal of the modulated-clock signal;
comparing the counting signal with a set value; and
generating a switching control signal when the counting signal reaches the set value.

11. The method according to claim 10, wherein the step of storing comprises storing a sequence of modulation values.

12. The method according to claim 10, wherein the modulated-clock signal has a variable frequency.

13. The method according to claim 10, wherein the step of generating a modulated-clock signal comprises:
receiving the sequence of modulation values; and
for each modulation value, counting clock pulses at a constant frequency and generating a modulated-clock pulse when the number of clock pulses at constant frequency is equal to the modulation value.

14. The method according to claim 13, further comprising the steps of:
receiving a pulse of the modulated-clock signal; and
generating a subsequent addressing signal for the memory.

15. An integrated device, comprising:
a modulated-clock generator configured to generate a modulated-clock signal having a frequency that varies according to a switching control law;
a counting circuit configured to generate a variable-frequency count signal in response to the modulated-clock signal;
a comparator having an input coupled to an output of the counting circuit and configured to compare the variable-frequency count signal with a set value and to generate a control signal that switches when the count signal reaches the set value; and
a driver circuit operating in response to the control signal to drive a string of light emitting diodes (LEDs).

16. The integrated device of claim 15, wherein the modulated-clock generator comprises a counter configured to:
receive a sequence of modulation values for said switching control law; and
for each modulation value, count clock pulses at constant frequency and generate a modulated-clock pulse when the number of clock pulses at constant frequency is equal to the modulation value
